(19) United States
(12) Patent Application Publication
(10) Pub. No.: US 2026/0106843 A1
(43) Pub. Date: Apr. 16, 2026

(54) METHOD AND SYSTEM FOR RANKING DATA CONNECTIVITY OF COMMUNICATION CHANNELS ESTABLISHED BETWEEN A DATA EXCHANGE SERVER AND A PLURALITY OF REMOTE SERVERS

(71) Applicant: Panax Tech Ltd., Tel Aviv (IL)

(72) Inventor: Yosef Haim ITZKOVICH, Tel Aviv (IL)

(73) Assignee: Panax Tech Ltd., Tel Aviv (IL)

(21) Appl. No.: 19/357,675

(22) Filed: Oct. 14, 2025

Related U.S. Application Data
(60) Provisional application No. 63/706,814, filed on Oct. 14, 2024.

(51) Int. Cl. H04L 47/78; H04L 41/16; H04L 43/0811; H04L 43/50; H04L 47/762; H04L 47/80

(52) U.S. Cl. CPC H04L 47/781; H04L 41/16; H04L 43/0811; H04L 43/50; H04L 47/762; H04L 47/805

(57) ABSTRACT

A system and method of ranking data connectivity of communication channels established between a data exchange server and a plurality of remote servers, wherein the data exchange server is configured to obtain data from the remote servers on behalf of end users connected to the data exchange server, the method comprising: collecting connectivity parameters by monitoring the data connectivity between the data exchange server and the remote servers; obtaining data connectivity requirements affecting data consumption at the end users; ranking the communication channels, based on the data connectivity parameters and further based on the data connectivity requirements, to allocate each one of the communication channels with a respective data connectivity ranking; and allocating the communication channels for each one of the remote servers and the respective end users based on the respective data connectivity ranking.

### CROSS REFERENCE TO RELATED APPLICATIONS

This application claims the benefit of U.S. Provisional Patent Application No. 63/706,814, filed Oct. 14, 2024, which is incorporated herein by reference in its entirety.

### FIELD OF THE INVENTION

The present invention relates generally to the field of data processing, and more particularly to ranking the connectivity of communication channels to remote data sources.

### BACKGROUND OF THE INVENTION

Modern distributed computing systems often rely on data exchange servers to obtain information from remote servers on behalf of end-user devices. However, network performance fluctuates significantly across communication channels due to varying factors such as latency, bandwidth constraints, congestion, and packet loss. In parallel, end-user devices may run applications with diverse and evolving connectivity requirements, such as low-latency requirements for video conferencing or high-throughput demands for file synchronization.

Conventional systems typically allocate communication channels using static rules or generic load balancing, failing to account for real-time network performance or individual user requirements, resulting in suboptimal data exchange efficiency and poor user experience.

There exists a need for a system that dynamically monitors, ranks, and allocates communication channels between a data exchange server and remote servers in a manner that is responsive to both network conditions and user-level requirements, thereby improving the overall quality and efficiency of data delivery.

While online banking for business users provides accurate transactional data, it lacks linking the transactions to the cashflow classification of the business. Traditionally, accountants and finance persons go over bank transactions periodically and attempt to label or tag the bank transaction7 with additional data based on their knowledge of the cashflow of the specific business.

Some solutions for building cashflow management platforms are starting to appear on the market, in order to help businesses make data-driven decisions to support both daily and long-term growth decisions, solving huge pain for finance teams.

However, in order to obtain the relevant financial data to support a cashflow and liquidity analysis from financial institutions, there is a need to connect a data exchange server to various data sources associated with financial institutions, to get full views on the cash and liquidity of the businesses. For each financial institution there are several connection methods for securely accessing financial data via a data exchange server.

One of the challenges of establishing comprehensive data access to financial institutions is to decide on which connection method to use for each financial institutions.

### SUMMARY OF THE INVENTION

In order to address the aforementioned challenges of selecting the most suitable data channels to financial institute, some embodiments of the present provide a ranking mechanism that relies on an analysis of the communication over all available channels as well as by factoring in the connectivity requirements of the businesses.

By doing so, embodiments of the present invention improve the basic technology of connecting a data exchange server to financial institutions by all available communication channels by applying a more selective optimization process.

According to embodiments of the present invention, a system and a method of ranking data connectivity of communication channels established between a data exchange server and a plurality of remote servers, wherein the data exchange server is configured to obtain data from the remote servers on behalf of end users connected to the data exchange server are provided herein. The method may include the following steps: collecting connectivity parameters by monitoring the data connectivity between the data exchange server and the remote servers; obtaining data connectivity requirements affecting data consumption at the end users; ranking the communication channels, based on the data connectivity parameters and further based on the data connectivity requirements, to allocate each one of the communication channels with a respective data connectivity ranking; and allocating the communication channels for each one of the remote servers and the respective end users based on the respective data connectivity ranking.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high-level block diagram illustrating a system for ranking communication channels between a data exchange server and remote data sources associated with financial institutions, in accordance with embodiments of the present invention; and

FIG. 2 is a high-level flowchart illustrating a method of ranking communication channels between a data exchange server and financial institutions, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In the foregoing detailed description, numerous specific details are set forth in order to provide an understanding of the invention. However, it will be understood by those skilled in the art that the invention can be practiced without these specific details. In other instances, well-known methods, procedures, and components, modules, units, and/or circuits have not been described in detail so as not to obscure the invention. Some features or elements described with respect to one embodiment can be combined with features or elements described with respect to other embodiments.

According to some embodiments of the present invention, there is provided A network-based system for optimizing data connectivity between a data exchange server and a plurality of remote servers, wherein the data exchange server is configured to retrieve data from the remote servers on behalf of end-user devices connected to the data exchange server, the system comprising: at least one computer processor and a non-transitory computer-readable memory storing executable instructions that, when executed by the processor, cause the system to: monitor network traffic metrics associated with a plurality of communication channels established between the data exchange server and the remote servers, and collect connectivity parameters, the connectivity parameters including at least latency, bandwidth, and packet loss; receive, from one or more end-user devices or associated applications, data connectivity requirements, the data connectivity requirements comprising latency sensitivity, throughput needs, or application-specific performance criteria; execute a ranking engine, by the data exchange server, to compute a data connectivity ranking for each communication channel based on the collected connectivity parameters and the data connectivity requirements; and dynamically allocate, in real time, the communication channels between the data exchange server and the remote servers for serving respective end-user devices, based on the computed data connectivity rankings, to optimize communication performance for ongoing data exchange sessions.

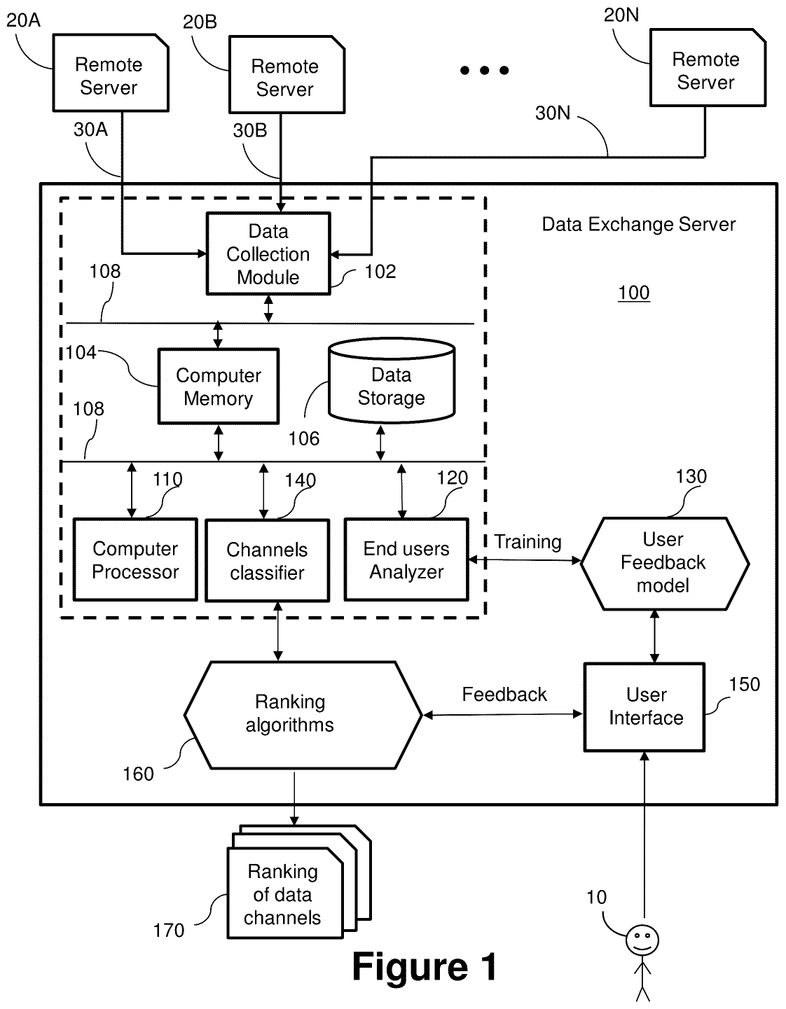

FIG. 1 is a high-level block diagram illustrating a system for ranking data connectivity of communication channels established 30A, 30B to 30N between a data exchange server 100 and a plurality of remote servers 20A, 20B to 20N each associated with a financial institution respectively.

By way of example, the data exchange server may connect to remote data sources of financial institution via different methods which may include but at not limited to:
1. Files Host to Host (H2H)—a method where the data exchange server connects directly to bank using file-based protocols.
2. Direct Application Programming Interface (API)—a method where the data exchange server connects directly to bank's APIs in case they are supported.
3. API Aggregators—a method where the data exchange server uses third party aggregators which covers hundreds/thousands of financial institution.
4. Cloud Provider Storage—a method where the data exchange server connects to all data sources via a cloud.

According to some embodiments, data exchange server 100 may be configured to obtain data from the remote servers 20A, 20B to 20N on behalf of end users (not shown) connected to the data exchange server 100. Data exchange server 100 may include a data collection module 102, which collects financial data from remote servers 20A, 20B to 20N over communication channels established 30A, 30B to 30N. Data exchange server 100 may further include a computer processor 110, a computer memory 104, and data storage 106. Data exchange server 100 may further include channels classifier 140 and end user's analyzer 120.

According to some embodiments, computer memory 104 may include a set of instructions that, when executed, cause one computer processor 104 to: collect connectivity parameters, possibly by channels classifier 140 applied on data collected by collection module 102, by monitoring the data connectivity between the data exchange server and the remote servers; obtain data connectivity requirements affecting data consumption at the end users possibly by end users analyzer 120 wherein the connectivity requirements data may be stored on storage 106; rank the communication channels, based on the data connectivity parameters and further based on the data connectivity requirements by applying ranking algorithms 160, to allocate each one of the communication channels 30A, 30B to 30N with a respective data connectivity ranking 170.

According to some embodiments, data exchange service 100 may further be configured to allocate the communication channels 30A, 30B to 30N for each one of the remote servers 20A, 20B to 20N and the respective end users based on the respective data connectivity ranking 170.

According to some embodiments, some of the end user connectivity requirements may be inputted by users such as user 10 via user interface 150 either as feedback affecting the ranking algorithms or by amending user feedback model 130 which results in adjusting the model which is used by end users analyzer 120 in determining the connectivity parameters required by the various end users.

According to some embodiments of the present invention, non-limiting examples for connectivity requirements may include:
1. Time to connect/complexity of connecting.
2. Data latency on the connection
3. Data richness (RT balance/historical balance API/transaction details richness)
4. Historical data backlog during connection (1/3/6/12 month and the like)
5. Up time score
6. Errors and incidents
7. Security level
8. Scaling factor—will connect 30 accounts will be 30x of connecting one on that connection.

According to some embodiments of the present invention, while considering all the aforementioned parameters, each connection available for that account are ranked and data exchange server returns the most suitable connection and its rank.

According to some embodiments of the present invention, possible improvement may be achieved by providing an adaptive ranking mechanism. User 10 may choose which parameters are most important to him or her via user interface 150 and provide more personalized ranking in the form of user feedback model 130.

According to some embodiments of the present invention, the connectivity parameters, ay include one or more of: latency, available bandwidth, packet loss rate, jitter, connection uptime, or historical communication failures.

According to some embodiments of the present invention, the data connectivity requirements may be based on one or more of: end user application type, priority level of the user, historical usage patterns, or service level agreement (SLA) parameters.

According to some embodiments of the present invention, the ranking of communication channels may be performed using a scoring algorithm that assigns a score to each communication channel based on a weighted sum of connectivity parameters and data connectivity requirements.

According to some embodiments of the present invention, the instructions may further cause the processor to: periodically re-rank the communication channels in response to changes in the connectivity parameters or data connectivity requirements.

According to some embodiments of the present invention, the allocation of communication channels may include assigning higher-ranked channels to end users with higher data connectivity requirements.

According to some embodiments of the present invention, the instructions may further cause the processor to: store the rankings and associated connectivity parameters in a database for historical analysis and performance optimization.

According to some embodiments of the present invention, the instructions may be configured to: identify degraded communication channels and trigger automated switching to alternate higher-ranked channels.

According to some embodiments of the present invention, the ranking may be performed by a machine learning model trained on historical data relating to data exchange success rates, end user experience metrics, and server response times.

According to some embodiments of the present invention, the monitoring of data connectivity may include passively collecting telemetry data or actively probing the communication channels with test signals.

According to some embodiments of the present invention, the allocation may include real-time updates to the communication channel assignments based on fluctuating network conditions.

In some other embodiments there is provided a computer-implemented method for improving data connectivity management in a distributed network environment comprising a data exchange server and a plurality of remote servers, wherein the data exchange server is configured to obtain data from the remote servers on behalf of end-user devices connected to the data exchange server.

According to some embodiments, the method may include the following steps: using at least one processor to monitor data traffic over communication channels between the data exchange server and the remote servers to collect connectivity parameters, the connectivity parameters comprising at least latency, bandwidth, and connection stability; obtaining, via the data exchange server, data connectivity requirements associated with at least one end-user device, the data connectivity requirements including at least latency sensitivity and data volume needs based on the application being used by the end-user device; executing a ranking algorithm, by the processor, to compute a respective data connectivity ranking for each communication channel, the ranking being based on the collected connectivity parameters and the data connectivity requirements; and automatically allocating, by the data exchange server, the communication channels for each of the remote servers and the corresponding end-user devices based on the respective data connectivity rankings, such that communication resources are dynamically optimized in real time to improve data transfer performance between the end-user devices and the remote servers.

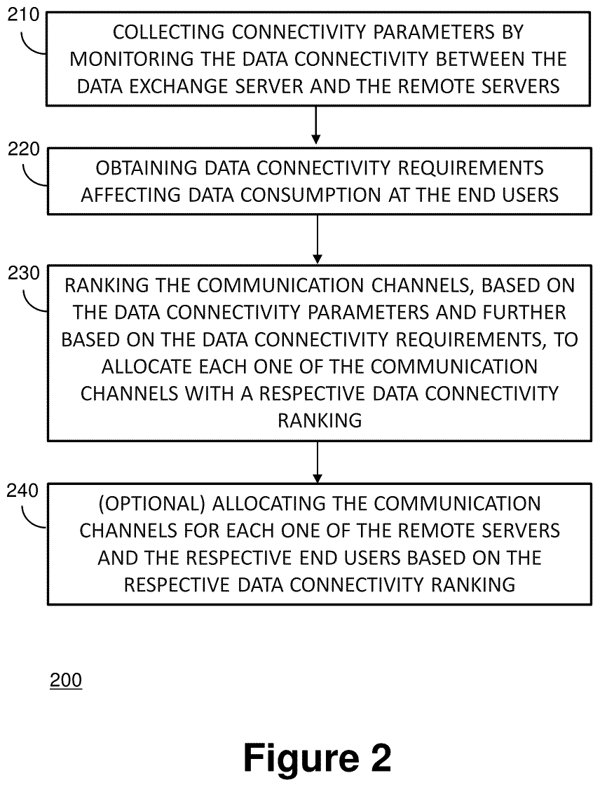

FIG. 2 is a high-level flowchart illustrating method 200 of ranking data connectivity of communication channels established between a data exchange server and a plurality of remote servers, wherein the data exchange server is configured to obtain data from the remote servers on behalf of end users connected to the data exchange server. Method 200 may include the following steps of: collecting connectivity parameters by monitoring the data connectivity between the data exchange server and the remote servers 210; obtaining data connectivity requirements affecting data consumption at the end users 220; and ranking the communication channels, based on the data connectivity parameters and further based on the data connectivity requirements, to allocate each one of the communication channels with a respective data connectivity ranking 230.

In some embodiments of the present invention, method 200 may optionally include the step of allocating the communication channels for each one of the remote servers and the respective end users based on the respective data connectivity ranking 240.

According to some embodiments of the present invention, the connectivity parameters may include one or more of: latency, bandwidth, packet loss, jitter, connection stability, or historical reliability data of the communication channels.

According to some embodiments of the present invention, the data connectivity requirements may include at least one of: real-time data access needs, data volume thresholds, user priority levels, or application-specific latency tolerance.

According to some embodiments of the present invention, ranking the communication channels further comprises assigning a numerical score to each communication channel based on a weighted combination of the connectivity parameters and the data connectivity requirements.

According to some embodiments of the present invention, allocating the communication channels includes dynamically switching the data path between the data exchange server and the remote servers in real-time based on updated rankings

According to some embodiments of the present invention, method 200 may further include the: periodically re-evaluating the data connectivity parameters to update the rankings of the communication channels.

According to some embodiments of the present invention, the ranking may be performed using a machine learning model trained on historical data exchange performance and user satisfaction metrics.

According to some embodiments of the present invention, method 200 may further include the step of: storing historical data on connectivity rankings to analyze trends and predict future communication performance.

According to some embodiments of the present invention, the end users may be associated with different service levels, and the allocation of communication channels is further based on service level agreement (SLA) compliance.

According to some embodiments of the present invention, the step of monitoring the data connectivity may include actively sending test packets or passively observing live traffic metrics.

According to some embodiments of the present invention, the ranking may include assigning a priority level to each communication channel, and the allocation step prioritizes high-priority channels for latency-sensitive or mission-critical applications.

The remainder of the description below includes several factors to consider in implementing the system in accordance with some embodiments of the present invention.

### Collecting Connectivity Parameter

According to some embodiments of the present invention, the processor, executing the instructions, continuously monitors data traffic over each communication channel. Connectivity parameters collected may include:
Latency (e.g., measured via round-trip time),
Bandwidth (e.g., available throughput over time),
Packet loss,
Jitter, and
Connection stability (e.g., reconnection frequency).

According to some embodiments of the present invention, this monitoring may involve active probing (e.g., ping, traceroute) or passive measurement of ongoing traffic.

### Obtaining Data Connectivity Requirements

According to some embodiments of the present invention, the system receives application-aware or user-specific requirements from end-user devices or associated software modules. These may include:
Real-time latency tolerance (e.g., for streaming or VoIP),
Throughput needs (e.g., for file transfers),
Reliability thresholds, or
Prioritization levels (e.g., based on service tier or criticality).

These requirements may be retrieved via API calls, headers in requests, or profiles associated with the user or device.

### Ranking Communication Channels

A ranking engine, implemented as software or hardware logic, computes a data connectivity score for each channel by applying a ranking algorithm. The algorithm may weigh the collected parameters against the requirements, for example as in formula (1) below:

$$Score = w 1 * Latency + w 2 * Bandwidth + w 3 * PacketLoss + w 4 * PriorityMatch \qquad Formula ( 1 )$$

According to some embodiments of the present invention, each communication channel may be assigned a data connectivity ranking based on the score.

### Allocating Communication Channels

According to some embodiments of the present invention, based on the computed rankings, the system allocates communication channels between the data exchange server and the remote servers such that the highest-ranking channels are assigned to latency-sensitive or high-priority end-user data sessions.

This allocation may be updated dynamically in response to changing network conditions or user demands.

Advantageously, the system according to some embodiments of the present invention provides several technical improvements over prior approaches:
Dynamic and real-time adaptation to fluctuating network conditions;
Personalized allocation of network resources based on user-level data consumption needs;
Reduced latency and improved bandwidth utilization through intelligent channel selection;
Scalability to handle large numbers of remote servers and user devices.

These improvements are achieved through specific network-level monitoring and processing logic and cannot be performed as a mental process or simple abstract idea. The system is rooted in computer and network technology and offers a practical application that improves how distributed systems exchange data.

The system may be implemented using cloud-based servers, on-premises data centers, or hybrid architecture. Communication monitoring may integrate with network performance monitoring tools, and ranking algorithms may be implemented using machine learning models trained on historical data. Allocation decisions may be exposed through APIs to allow third-party integration.

It is further understood that some embodiments of the present invention may be embodied in the form of a system, a method, or a computer program product. Similarly, some embodiments may be embodied as hardware, software, or a combination of both. Some embodiments may be embodied as a computer program product saved on one or more non-transitory computer-readable medium (or media) in the form of computer-readable program code embodied thereon. Such non-transitory computer-readable medium may include instructions that when executed cause a processor to execute method steps in accordance with embodiments. In some embodiments, the instructions stored on the computer-readable medium may be in the form of an installed application and in the form of an installation package.

Such instructions may be, for example, loaded by one or more processors and executed. For example, the computer-readable medium may be a non-transitory computer-readable storage medium. A non-transitory computer-readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units, and/or circuits have not been described in detail so as not to obscure the invention. Some features or elements described with respect to one embodiment can be combined with features or elements described with respect to other embodiments.

1. A method of ranking data connectivity of communication channels established between a data exchange server and a plurality of remote servers, wherein the data exchange server is configured to obtain data from the remote servers on behalf of end users connected to the data exchange server, the method comprising:
collecting connectivity parameters by monitoring the data connectivity between the data exchange server and the remote servers;
obtaining data connectivity requirements affecting data consumption at the end users;
ranking the communication channels, based on the data connectivity parameters and further based on the data connectivity requirements, to allocate each one of the communication channels with a respective data connectivity ranking; and
allocating the communication channels for each one of the remote servers and the respective end users based on the respective data connectivity ranking.

2. The method of claim 1, wherein the connectivity parameters comprise one or more of: latency, bandwidth, packet loss, jitter, connection stability, or historical reliability data of the communication channels.

3. The method of claim 1, wherein the data connectivity requirements include at least one of: real-time data access needs, data volume thresholds, user priority levels, or application-specific latency tolerance.

4. The method of claim 1, wherein ranking the communication channels further comprises assigning a numerical score to each communication channel based on a weighted combination of the connectivity parameters and the data connectivity requirements.

5. The method of claim 1, wherein allocating the communication channels includes dynamically switching a data path between the data exchange server and the remote servers in real-time based on updated rankings.

6. The method of claim 1, further comprising: periodically re-evaluating the data connectivity parameters to update the rankings of the communication channels.

7. The method of claim 1, wherein the ranking is performed using a machine learning model trained on historical data exchange performance and user satisfaction metrics.

8. The method of claim 1, further comprising: storing historical data on connectivity rankings to analyze trends and predict future communication performance.

9. The method of claim 1, wherein the end users are associated with different service levels, and the allocation of communication channels is further based on service level agreement (SLA) compliance.

10. The method of claim 1, wherein monitoring the data connectivity includes actively sending test packets or passively observing live traffic metrics.

11. A system for ranking data connectivity of communication channels established between a data exchange server and a plurality of remote servers, wherein the data exchange server is configured to obtain data from the remote servers on behalf of end users connected to the data exchange server, the system comprising:
a computer memory comprising a set of instructions that, when executed, cause at least one computer processor to:
collect connectivity parameters by monitoring the data connectivity between the data exchange server and the remote servers;
obtain data connectivity requirements affecting data consumption at the end users;
rank the communication channels, based on the data connectivity parameters and further based on the data connectivity requirements, to allocate each one of the communication channels with a respective data connectivity ranking; and
allocate the communication channels for each one of the remote servers and the respective end users based on the respective data connectivity ranking.

12. The system of claim 11, wherein the connectivity parameters comprise one or more of: latency, available bandwidth, packet loss rate, jitter, connection uptime, or historical communication failures.

13. The system of claim 11, wherein the data connectivity requirements are based on one or more of:
end user application type, priority level of the user, historical usage patterns, or service level agreement (SLA) parameters.

14. The system of claim 11, wherein the ranking of communication channels is performed using a scoring algorithm that assigns a score to each communication channel based on a weighted sum of connectivity parameters and data connectivity requirements.

15. The system of claim 11, wherein the instructions further cause the processor to: periodically re-rank the communication channels in response to changes in the connectivity parameters or data connectivity requirements.

16. The system of claim 11, wherein the allocation of communication channels comprises assigning higher-ranked channels to end users with higher data connectivity requirements.

17. The system of claim 11, wherein the instructions further cause the processor to: store the rankings and associated connectivity parameters in a database for historical analysis and performance optimization.

18. The system of claim 11, wherein the instructions are configured to: identify degraded communication channels and trigger automated switching to alternate higher-ranked channels.

19. The system of claim 11, wherein the ranking is performed by a machine learning model trained on historical data relating to data exchange success rates, end user experience metrics, and server response times.

20. The system of claim 11, wherein the monitoring of data connectivity comprises passively collecting telemetry data or actively probing the communication channels with test signals.
